(19) United States
(12) Patent Application Publication
(10) Pub. No.: US 2016/0176745 A1
(43) Pub. Date: Jun. 23, 2016

(54) Method and apparatus for the automated production of glass objects with a preset wall thickness, preferably for electrochemical sensors

(71) Applicant: Endress + Hauser Conducta Gesellschaft für Mess- und Regeltechnik mbH + Co. KG, Gerlingen (DE)

(72) Inventors: Roland Zilly, Jahnsdorf (DE); Carsten Enderwitz, Waldheim (DE); Tom Druding, Naunhof (DE); Jens Bindrich, Dresden (DE)

(21) Appl. No.: 14/970,913

(22) Filed: Dec. 16, 2015

(30) Foreign Application Priority Data
Dec. 22, 2014 (DE) 10 2014 119 402.0
Aug. 28, 2015 (DE) 10 2015 114 334.8

(51) Int. Cl. C03B 9/41; G05B 19/18

(52) U.S. Cl. CPC C03B 9/41; G05B 19/182; G05B 2219/45009

(57) ABSTRACT

A method for the automated production of glass objects with a preset wall thickness, comprising: producing a series of glass objects, wherein each one of the glass objects of the series is produced by a process influenced by at least one process parameter; automatic measurement of an actual wall thickness of at least one of the glass objects and comparing the actual wall thickness with a preset target wall thickness; and automatic adjustment of at least one process parameter, based on the comparison of the actual wall thickness with the preset target thickness.

The invention relates to a method for the automated production of glass objects with a preset wall thickness, preferably for electrochemical sensors. A series of such glass objects is manufactured by this method, wherein each one of the glass objects of the series is produced by a process influenced by at least one process parameter. The invention also relates to an apparatus for implementing the method.

An automated process and apparatus for producing a blow-molded glass object are known from DE 101 16 099 B4. In this automated method, a dip tube through which air or gas flows is immersed in a glass melt and then pulled out again to remove a quantity of molten glass from the glass melt. In this case, the removed glass is blown to the shape of the glass object by means of air or gas flowing through the dip tube. Using a computer-controlled control device, the actual geometry of the glass objects produced is compared with a target state of the object geometry by comparing the reference points of the target state, which are stored in the computing unit, with the actual object geometry of the glass object using an image processing device. The blow-molding process is controlled due to these differences between the target and measured geometry.

Based on the process, the dip tubes used in the series production of blow-molded glass objects show minor deviations among themselves in terms of their geometry, in particular their diameter, wall thickness and plane symmetry. This difference is seen during the entire manufacturing process and results in the variations in the geometry of the glass object. For example, the quantity of molten glass removed from the glass melt using the dip tube also has a major influence on the geometry of the glass object. A variance of the geometry of the end portion of the dip tube immersed into the glass melt leads to a difference in the quantity of molten glass that is withdrawn while dipping into the glass melt, and therefore, also in a variation in the geometries of the glass objects produced therefrom. The wall thickness is also decisive for the quality assessment of the produced glass object. Despite the automated manufacturing process, the wall thickness of the glass object produced is manually controlled at the start of a batch and during individual test steps within a batch. If serious errors related to wall thickness are detected, the operator adjusts the process parameters of the blow-molding process. Such a manual process is very time consuming and not always accurate.

The object of the invention is to provide a method and an apparatus for the automated production of glass objects, in which the wall thickness can be checked and changed in less time.

According to the invention the object is accomplished by the fact that the method comprises the following steps:
producing a series of glass objects, wherein each one of the glass objects of the series is produced by a process influenced by at least one process parameter;
automatic measurement of an actual wall thickness of at least one of the glass objects and comparing the actual wall thickness or a value derived therefrom with a preset target wall thickness;
automatic adjustment of at least one process parameter, based on the comparison of the actual wall thickness with the preset target thickness.

This has the advantage that the wall thickness of the glass objects of the series produced after adjustment of the at least one process parameter can be automatically adjusted in the production process of a series of glass objects by automatic modification of the process for producing the individual glass objects upon detection of a deviation of the actual wall thickness from the target wall thickness, namely adjustment of at least one process parameter to change their wall thickness to the target wall thickness.

The process for the production of the individual glass objects of the series may include immersing a dip tube, through which gas flows, in a glass melt and then pulling out the dip tube from the glass melt, wherein a quantity of the molten glass taken from the glass melt is blown by a gas, flowing through the dip tube, to form the glass object.

Following the adjustment of the at least one process parameter, production of a series of glass objects can be continued with the at least one adjusted process parameter.

In one embodiment, a wall thickness of at least one of the glass objects produced is automatically measured and compared with a target wall thickness and upon deviation of the actual wall thickness from the target wall thickness, automatic control for automatic adjustment of a process parameter influencing a blowing operation for forming the glass object adjusts the actual wall thickness to the target wall thickness.

When detecting the deviation of the actual wall thickness from the target wall thickness, one or more parameters of the manufacturing process of the glass object can be changed to automatically adjust the wall thickness to the target wall thickness.

Advantageously, the actual wall thickness of the produced glass objects is measured at predetermined time intervals, wherein a mean value is calculated from the actual wall thickness of a predetermined number of produced glass objects and compared with the target wall thickness. Although only actual wall thickness values of the individual glass objects are determined at predetermined time intervals, the calculation of the mean value allows determination of a relationship between the actual wall thickness of the glass objects produced and the target wall thickness. Based on this determined relationship, the control system influences the manufacturing process of the glass objects. In doing this, the blowing process of the glass objects are changed such that the actual wall thickness is again identical to the target wall thickness.

In one embodiment, the mean value is a moving average of the predetermined number of glass objects produced. Thus, this moving average reveals the direction of the changing wall thickness, so that it can be determined at any time whether the production parameters of the blowing process were adjusted in the right direction for setting the target wall thickness.

In one embodiment, production-specific process parameters, such as a blowing pressure are changed over time when setting the blowing process. In this case, the parameter of the constant blowing pressure over time is of special significance to the glass object in the form of flat membranes, while the parameter of the blowing pressure over time is of special significance to a glass object in the form of a spherical membrane.

In one embodiment, a confocal measuring system or an imaging device is used for automatic measurement of the wall thickness during production. These measuring devices can easily be integrated into the production process as both of them are based on an optical method and thus, do not require any design-related changes to the production process.

An embodiment of the invention relates to an apparatus for the automated production of glass objects, having a predetermined wall thickness, preferably for electro-chemical sensors, comprising a computer-based control unit, which controls a process apparatus while producing a series of glass objects, wherein each one of the glass objects of the series is produced by a process influenced by at least one process parameter, in particular of a blowing process. In a device, in which the wall thickness of the glass objects can simply and easily be monitored, a wall thickness measuring device for determining the wall thickness of each glass object is arranged downstream to the process apparatus, which is connected to the control unit for transmitting the actual wall thickness of the glass object measured, said control unit adjusts the process parameter of the process apparatus for changing the process, in particular a blowing process, for the manufacture of the individual glass objects, to the target wall thickness by comparing the actual wall thickness of at least one of the glass objects or a value derived therefrom with a target wall thickness. This has the advantage that a trend of the wall thickness of the glass object produced in a production cycle can easily and quickly be determined, wherein the wall thickness of the glass objects can still be changed during production of a series. Thus, the production of rejects is reduced as the wall thickness of the produced glass objects can still be found during production.

Advantageously, the wall thickness measuring device is designed as a confocal measuring device or imaging device. Using these wall thickness measuring devices, based on optical measurement systems, the wall thickness of the glass objects can be controlled in a regulation system during the production process.

The invention allows numerous embodiments. One of these will be explained with reference to figures illustrated in the drawing.

It shows:

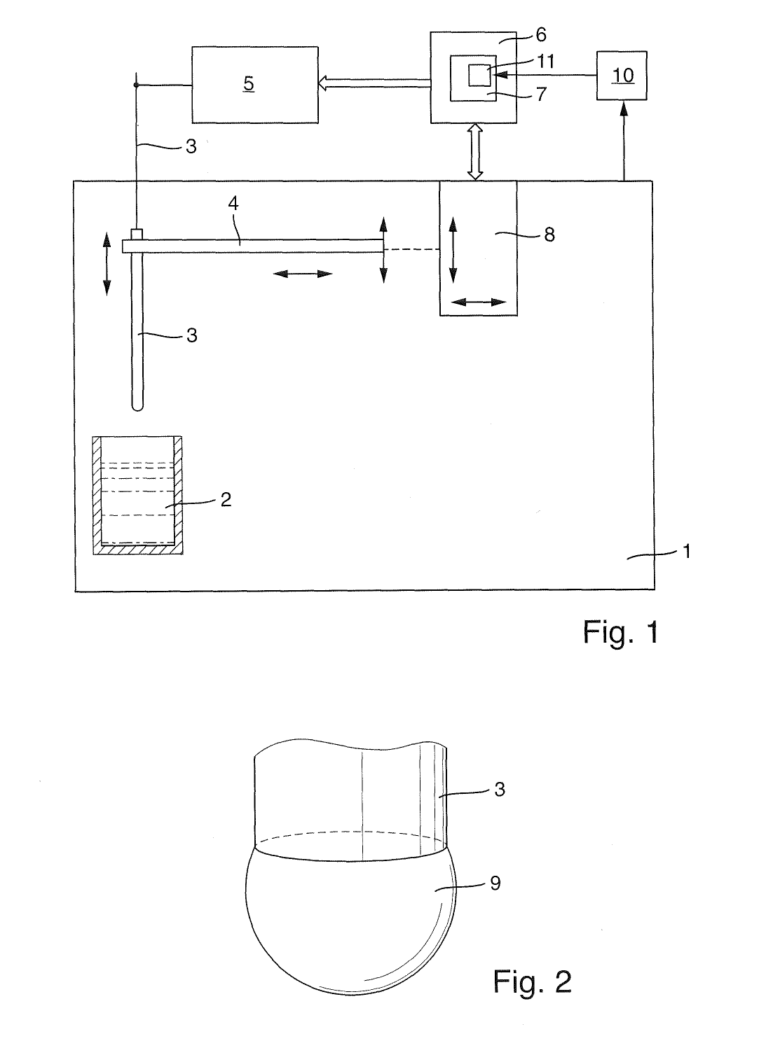

FIG. 1 an embodiment of the inventive device for setting a wall thickness,

FIG. 2 an embodiment of a glass object blown at a dip tube.

The same features are identified by the same reference numerals.

FIG. 1 illustrates an embodiment of a device for production of a series of glass objects. Such a glass object can be, for example, a spherical membrane for a pH sensor. The apparatus comprises a process apparatus 1, comprising a glass-melting device 2, in which a dip tube 3 is immersed and pulled out again by means of a retaining device 4. The dip tube 3 is connected via a flexible hose to a compressed air device 5, which leads to a control system 6, comprising a computing unit 7. Using an actuating device 8, which is connected to the retaining device 4 as well as the control system 6, the dip tube 3 is lowered into the melting device 2 and pulled out again. In the process, the dip tube 3 takes a quantity of the molten glass from a glass melting device 2. By the supply of compressed air from the compressed air device 5, controlled by the computing unit 6, a glass membrane, forming the glass object 9, is blown as shown in FIG. 2.

A wall thickness measuring device 10, which measures the wall thickness of the glass membrane produced is connected to the process apparatus 1. In such a wall thickness measuring device 10, a confocal measuring system is used for optical and contactless measurement of wall thickness. Such confocal measuring systems transmit a wide light spectrum, wherein—depending on the wall thickness—corresponding reflections are generated which are evaluated by the wall thickness measuring device 10. Using these reflections, the wall thickness may be calculated using the respective refractive index.

In this manner, the wall thickness of the glass object 9 produced successively in series is measured by the device at predetermined time intervals, wherein the wall thickness values of a plurality of glass membranes are sent to the control unit 6. The control unit 6 stores this data in a memory and uses the predetermined number of wall thickness values to calculate mean values, which are forwarded to software-like regulator 11 that is formed in the control device 6. Since the mean value is calculated as a moving average, wherein the oldest value of the wall thickness is always eliminated and a next value of the wall thickness of another glass object 9 is included, a trend in the wall thickness of the glass objects 9 can preferably be determined.

The regulator 11 is programmed so that it starts control of the wall thickness of the glass objects 9 after a variably set number of glass objects 9. Due to the deviations determined by the regulator 10 between the mean value and the target wall thickness, the blowing curve of the glass objects 9 is changed in the process unit 1. In particular, the blowing process during this period is varied over a period of time as a process parameter influencing the blowing process. This occurs due to the fact that the control device 6 accordingly controls the compressed air device 5.

Thus, the production-specific adjustment parameters of the manufacturing process of each glass object are changed automatically after repeated detection of a deviation of the mean value of the actual wall thickness from the preset target thickness, so that the subsequently produced glass objects 9 possess the target wall thickness and thus, the required quality. This method described above is applicable to both glass object in the form of flat membranes and to glass objects which are configured as spherical membranes.

1-10. (canceled)

11. A method for the automated production of glass objects with a preset wall thickness, comprising:
producing a series of glass objects, wherein each one of the glass objects of the series is produced by a process influenced by at least one process parameter;
automatic measurement of an actual wall thickness of at least one of the glass objects and comparing the actual wall thickness or a value derived therefrom with a preset target wall thickness; and
automatic adjustment of at least one process parameter, based on the comparison of the actual wall thickness with the preset target thickness.

12. The method according to claim 11, further comprises:
immersion of a dip tube, through which a gas flows into a glass melt and then pulling out the dip tube from the glass melt, wherein a quantity of the molten glass taken from the glass melt is blown by a gas, flowing through the dip tube, to form the glass object.

13. The method according to claim 11, wherein:
the production of a series of glass objects is continued with the adjusted process parameter following adjusting of the at least one process parameter.

14. The method according to claim 11, wherein:
the actual wall thickness of the glass object(s) is automatically measured and compared with the target wall thickness and in case of a deviation of the actual wall thickness from the target wall thickness, a control system for setting a process parameter, influencing a blowing operation for forming the glass object, is automatically adjusted to the target wall thickness.

15. The method according to claim 11, wherein:
the actual wall thickness values of the produced glass objects are measured at predetermined time intervals; and
wherein a mean value is calculated from the actual wall thickness values of a predetermined number of produced glass objects of the series and compared with the target wall thickness.

16. The method according to claim 15, wherein:
the mean value is a moving average of the predetermined number of manufactured glass objects of the series.

17. The method according to claim 12, wherein:
the at least one process parameter is a blowing pressure, in particular a blowing pressure as a function of time, with which the gas flows through the dip tube to form the glass object.

18. The method according to claim 16, wherein:
a confocal measuring system or an imaging device is used for automatic measurement of the actual wall thickness.

19. An apparatus for the automated production of glass objects, having a predetermined wall thickness, preferably for electro-chemical sensors, comprising:
a computer-based control system, which controls a process apparatus while producing a series of glass objects, wherein each one of said glass objects of the series is produced by a process influenced by at least one process parameter;
a wall thickness measuring device for determining an actual wall thickness of a glass object arranged downstream to the process apparatus, which is connected to the control system for transmitting the measured actual wall thickness, said control system adjusts the at least one process parameter of the process apparatus for changing the process for the manufacture of each glass object to the target wall thickness by comparing the actual wall thickness or a value derived therefrom with a predetermined target wall thickness.

20. The apparatus according to claim 19, wherein:
said wall thickness measuring device is formed as a confocal measuring device or as an imaging device.
